(19) United States
(12) Patent Application Publication
(10) Pub. No.: US 2014/0299679 A1
(43) Pub. Date: Oct. 9, 2014

(54) DISPENSING HEAD FOR A SYSTEM FOR DISPENSING A PRESSURISED PRODUCT

(71) Applicant: ALBEA LE TREPORT, Le Treport (FR)

(72) Inventors: Richard Bloc, Derchigny-Graincourt (FR); Bernard Clerget, Haudivillers (FR)

(21) Appl. No.: 14/355,159

(22) PCT Filed: Nov. 15, 2012
(86) PCT No.: PCT/FR2012/052639

§ 371 Date: Apr. 29, 2014

(30) Foreign Application Priority Data
Nov. 17, 2011 (FR) 1160493

(51) Int. Cl. F02M 61/00

(52) U.S. Cl. CPC B05B 11/3052
USPC 239/533.12

(57) ABSTRACT

The invention relates to a dispensing head (2) for a system for dispensing a pressurised product, said head comprising a body (8) presenting a shaft (9) for mounting said head on a tube (7) supplying the pressurised product and a housing that communicates with said shaft, said housing having an insert (11) enveloped by a sleeve (12) thereby forming a path (13) for dispensing the product between said shaft and a dispensing orifice (14) formed in a wall (15) of said sleeve, which is arranged facing a wall (16) of said insert, where at least one of the walls (15, 16) of the sleeve (12) and the insert (11) present a surface suitable for entering into contact with g the product, said surface comprising metallic copper.

The invention concerns a dispensing head for a system for dispensing a pressurised product, a dispensing system comprising such a head fixed to a tube for feeding the pressurised product and a bottle containing a product to be dispensed under pressure by means of such a dispensing system.

In a particular application, the product is of the lotion, gel or cream type, for example for cosmetic use or for pharmaceutical treatments.

Dispensing systems are known comprising a pump provided with a tube for feeding the pressurised product on which a dispensing head of the push button type is fixed in order to activate the movement of said tube on a product dispensing/aspiration travel.

In particular, the dispensing head may comprise a body having a well for mounting said head on the feed tube and a housing in communication with said well. The housing is equipped with an insert around which a sleeve is disposed in order to form a path for dispensing the product between the mounting well and a dispensing orifice formed in a wall of said sleeve that is disposed opposite a wall of said insert. Thus, by pressing on the body of the dispensing head, the pump is actuated in order to dispense the product through the dispensing orifice in the form of a blob or a continuous stream.

Throughout the world various directives aim to regulate, control and limit the presence of substances potentially hazardous for human health in products, in particular cosmetic products. One of them is the European Directive REACh (Registration Evaluation and Authorisation of Chemicals). Also an environmental trend prompts cosmeticians to limit, or even eliminate from their formulae, preservatives, which often cause allergies or intolerances.

Cosmetic products are therefore becoming more and more fragile. In particular, it is difficult for them to withstand mechanical or thermal stress (causing for example phase separation), or contact with air (causing for example drying or oxidation), and can easily be contaminated by bacteria and fungi.

To combat contamination, formulators attempt to reinforce the intrinsic preservative activity of their products by adding ingredients having a preservative activity, such as certain essential oils, orange essences, vitamin C, etc., which are not declared as preservatives. Also they limit the free activity of water, which they attempt to keep low (AW<0.6) so that the bacteria do not develop or develop only a little. However, formulators quickly come up against the limits of such a strategy.

On the other hand, protective dispensing systems are appearing on the market. In particular, systems have been proposed wherein the outlet channels are not very narrow and not very tortuous in order not to subject the product to pressures during dispensing thereof Systems have also been proposed without take-up of air, referred to as “airless”, in which the air does not enter in compensation for the volume of product dispensed, or wherein the incoming air is filtered through a mesh of around 0.2 μm in order to retain bacteria and fungi.

Systems have also been proposed wherein the dispensing orifice is self-closing, thus limiting the contact of the product with air between two dispensings. However, this mechanical self-closing, formed at the interface of two geometries that are often imperfect, cannot claim to achieve complete retention of bacteria and fungi with a size of a few tenths of a micrometre.

To solve these problems of contamination, systems have been proposed using materials containing antimicrobial agents, for example on an organic base such as Trichlosan (trade name of the company Melcoplast) or on a silver base, said materials being located in an area of contact with the product in order to prevent the contamination of the film of product contained in the dispensing orifice.

However, these antimicrobial agents, added to the materials constituting the dispensing system, may migrate into the product, that is to say the product becomes loaded with an uncontrolled quantity of preservatives whereas the formulator did not wish this. Furthermore, the activity of the organic antimicrobial agents greatly decreases after radio-crosslinking for sterilising the product, and also through natural aging.

The invention aims to improve the prior art by proposing in particular a dispensing system with an antimicrobial property that is reliable over time and in which no antimicrobial agent is liable to migrate into the product to be dispensed.

Furthermore, the invention proposes a dispensing system with an improved antimicrobial property so as to be able to dispense products with a limited or even zero preservative content. Consequently the combined use of a dispensing system according to the invention with a bottle containing such a type of product is particularly advantageous.

The combined use of a dispensing system according to the invention with a bottle containing a product to be dispensed is also particularly advantageous when the intrinsic preservative activity of said product is improved, for example by adding ingredients having a preservative activity, such as certain essential oils, orange essences or vitamin C and/or by limiting the free activity of water (AW<0.6).

To achieve these various improvements, according to a first aspect, the invention proposes a dispensing head for a system for dispensing a pressurised product, said head comprising a body having a well for mounting said head on a tube for feeding pressurised product and a housing in communication with said well, said housing being equipped with an insert around which a sleeve is disposed to form a path for dispensing product between said well and a dispensing orifice formed in a wall of said sleeve that is disposed opposite a wall of said insert, at least one of the walls of the sleeve and of the insert having a surface intended to be in contact with the product, said surface comprising metallic copper.

According to a second aspect, the invention proposes a system for dispensing a pressurised product comprising such a dispensing head and a tube for feeding the pressurised product on which the well for mounting said head is fixed.

According to a third aspect, the invention proposes a bottle containing a product to be dispensed under pressure, said bottle comprising a neck on which such a dispensing system is associated so as to put the feed tube in communication with the product in order to enable the product to be routed from said feed tube to the dispensing orifice.

Other objects and advantages of the invention will appear in the following description, given with reference to the accompanying figures, in which:

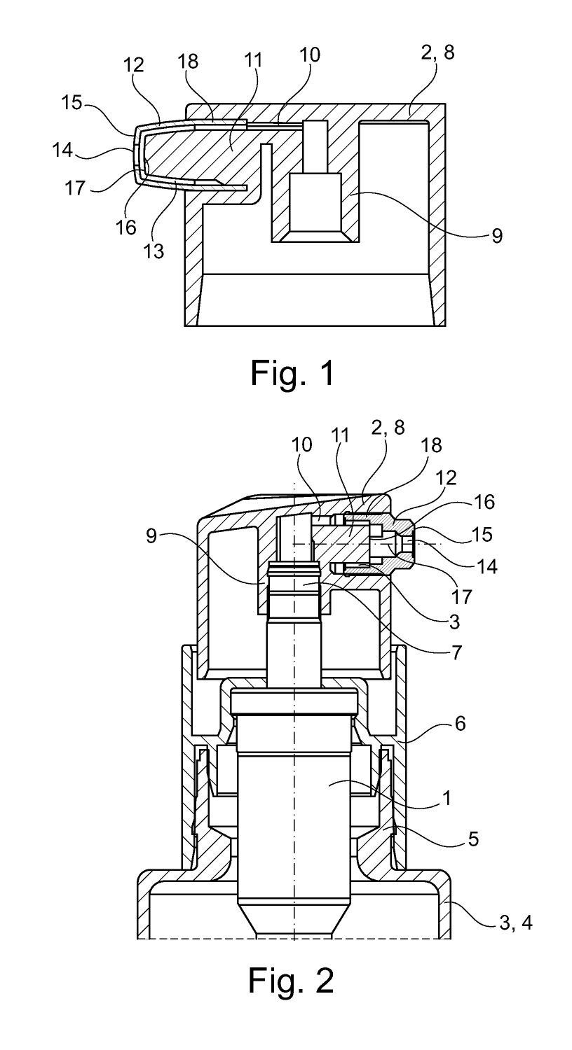

FIG. 1 is a view in longitudinal section of a dispensing head according to one embodiment of the invention;

FIGS. 2 to 4 are partial views in longitudinal section of a bottle equipped with a dispensing system according respectively to one embodiment of the invention.

In relation to the figures, a dispensing system is described comprising a pump 1 actuated by a dispensing head 2 of the push button type to enable a pressurised product to be dispensed, for example in the form of a blob or a continuous stream.

To do this, the dispensing system is mounted on a bottle 3 containing the product to be dispensed under pressure. In an example application, the product is a lotion, a gel or a cream, for cosmetic use or for pharmaceutical treatments.

The bottle 3 comprises a body 4 surmounted by a neck 5 and the dispensing system comprises a hoop 6 on which the pump 1 is mounted, said hoop being associated with the neck 5 so as to put the pump 1 in sealed communication with the product packaged in said body.

In the figures, the pump 1 is not cut but conventionally comprises a body in which means necessary for pressurising the product to be dispensed are disposed. According to a particular embodiment, the pump 1 is of the type without take-up of air in compensation for the volume of product dispensed, so as not to introduce contaminant into the packaged product.

The invention is not limited to a particular structure of the pump 1, nor to a particular method for mounting the pump 1 on the bottle 3. Furthermore, the pump 1 can be supplied with packaged product by means of a plunger tube disposed in the bottle 3 or by means of a product-feed piston that is mounted slidably in the body 4 so as to push the product into the pump 1.

The pump 1 comprises a tube 7 for feeding the pressurised product, said tube being movable reversibly over a product dispensing/aspiration travel. To activate this movement, the dispensing head 2 is mounted on the downstream part of the feed tube 7, said head comprising a body 8 having a well 9 for mounting said head on said feed tube.

The dispensing head 2 has a housing in communication with the mounting well 9 by means of a channel 10, said housing being equipped with an insert 11 around which a sleeve 12 is disposed in order to form a path 13 for dispensing the product between said well and a dispensing orifice 14. Thus, by fixing the mounting well 9 on the feed tube 7, the dispensing of the product is achieved by pressing on the body 8 in order to activate the movement of said tube so as to route the packaged product from the feed tube 7 to the dispensing orifice 14.

The dispensing system may also be used for other types of dispensing. In particular, the bottle 3 may comprise a flexible body 4, the pressurisation of the product in the feed tube 7 then being done by moving the walls of said bottle closer to each other, without using a pump.

The dispensing orifice 14 is formed in a wall 15 of the sleeve 12 that is disposed opposite a wall 16 of the insert 11. The sleeve 12 and the insert 11 have surfaces that are intended to be in contact with the product, in particular the surfaces delimiting between them the dispensing path 13 in which product is immobilised between two dispensings as well as the external surface of the wall 15 of the sleeve 12 on which stains of dispensed product are formed, in particular by spreading of said product on said surface during recovery thereof by the finger of the user.

In order to limit the contamination of the product by bacteria and fungi, at least one of the contact surfaces of the walls 15, 16 of the sleeve 12 and of the insert 11 comprises metallic copper which, through the microbiostatic properties thereof, prevents the proliferation of or even eliminates the contaminants in contact with said surfaces, and this without migration of any antimicrobial agent into the product. Thus decontamination is ensured for the product which, between two dispensings, is located in the vicinity of the dispensing orifice 14, and the entry of bacteria and fungi into the bottle 3 by means of the dispensing path 13 is prevented.

In particular, the external surface of the wall 15 of the sleeve 12 comprises metallic copper for preventing contamination of the stains disposed on it between two dispensings, thus ensuring that the product dispensed subsequently is not contaminated by said stains. Likewise, the peripheral surface delimiting the dispensing orifice 14 comprises metallic copper since the product contained in said orifice between two dispensings is also in contact with the air.

Advantageously, the pump 1 may also contain metallic copper, in particular at the components of said pump that are in contact with the pressurised product. Thus, by contact with metallic copper, proliferation of the contaminants of the product contained in the pump before it is dispensed through the feed tube 7 is prevented or even eliminated.

In particular, a pump 1 conventionally comprises a ball forming an inlet valve for the product, said ball being able to be produced from metallic copper. Likewise, the spring enabling the feed tube 7 to return over its aspiration travel can be produced from metallic copper, in particular when this spring is disposed in the product apportioning chamber.

The maximum dimension of the dispensing orifice 14 may be less than or equal to 0.5 mm, for example while having a rectangular shape, in order to limit the maximum distance separating the copper from the product contained in said orifice. Thus, by surface effect on a very thin film of product, decontamination of the product contained in the dispensing orifice 14 is ensured. Furthermore, the dispensing path 13 may have a thickness that is less than or equal to 0.5 mm so that the product is laminated over a very small thickness before feeding the dispensing orifice 14.

Moreover, the walls 16, 15 of the insert 11 and of the sleeve 12 delimit between them a volume 17 intended to contain product, said volume defining the downstream end of the dispensing path 13 that is in direct communication with the dispensing orifice 14. This volume 17, being firstly close to the dispensing orifice 14 and secondly in contact with the rest of the packaged product, can be delimited by at least one surface comprising metallic copper, in particular the inside surface of the wall 15 of the sleeve 12 can advantageously comprise metallic copper.

Furthermore, the volume 17 delimited between the walls 15, 16 may be less than 0.1 mm³ in order to limit the maximum distance separating the copper from the product contained is said volume. Thus, by surface effect over a very small volume of product, decontamination of the product contained in said volume is ensured.

According to one embodiment, the sleeve 12 and/or the insert 11 is produced from synthetic material, for example of the polyolefin type, at least one surface of which intended to be in contact with the product is metallised with a deposit of copper. According to another embodiment, the sleeve 12 and/or the insert 11 is produced from metallic copper. In particular, in FIG. 1, the sleeve 12 is produced entirely by the shaping of a foil of metallic copper.

In these embodiments, when part of the sleeve 12 is visible to the user, provision can be made for the copper to be visible on said part so that said user can identify the microbiostatic properties of the dispensing system.

According to another embodiment, the sleeve 12 and/or the insert 11 is produced from synthetic material, for example of the polyolefin type, which contains particles of metallic copper, the degree of filling being sufficient for particles of copper to be disposed on the surface so as to be in contact with the product.

In relation to FIGS. 1 to 3, the sleeve 12 is rigid and has a skirt 18 that is fitted in the housing, said skirt being enclosed towards the front by a radial wall 15 in which the dispensing orifice 14 is formed. Furthermore, the sleeve 12 is mounted around the insert 11 in order to form between them an annular part of the dispensing path 13, said insert having a radial wall 16 that is disposed axially opposite the dispensing orifice 14, forming a volume 17 in communication firstly with said annular part and secondly with the dispensing orifice 14.

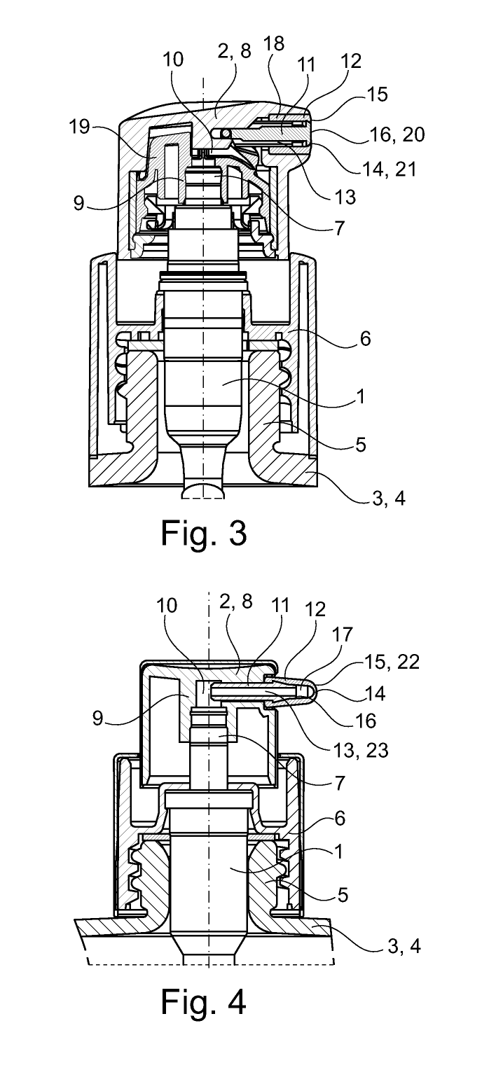

In FIG. 3, the insert 11 can be moved reversibly between a closure position (FIG. 3) and an open position of the dispensing orifice 14 to allow the reversible closure of said orifice between two uses. This figure shows a known embodiment of the document FR-2 948 343 in which the movement of the insert 11 is achieved by means of a piece 19 having the mounting well 9, the body 8 being slidably mounted around said piece between a high position and a low position, said insert being mounted between the body 8 and the piece 19 by means of a device for the reversible movement of said insert.

In this embodiment, the insert 11 has a head 20 forming a surface 16 which, in the closure position, is sealingly received in a seat 21 formed on the peripheral surface of the orifice 14, said head being disposed at a distance from said seat in the open position. Advantageously, at least the surface 16 of the head 20 or the seat 21 comprises metallic copper to ensure decontamination of the film of product retained on the interface between them when the insert 11 is in the closure position.

In relation to FIG. 4, the sleeve 12 is reversibly deformable between a closed state (FIG. 4) and an open state of the dispensing orifice 14. In particular, the sleeve 12 is produced from elastomer material in a surface 15 of which at least one lip 22 is formed, movable by applying the pressure of the product dispensed on it, said sleeve being disposed around the insert 11, which can be attached in the body 8 (FIG. 4) or integrated therein. Moreover, the insert 11 has an internal conduit 23 forming the dispensing path 13 that emerges on a radial surface 16 disposed opposite the dispensing orifice 14.

In this embodiment, at least the lip 22 can be loaded with copper particles while keeping sufficient elasticity properties for the sleeve 12 in order to ensure decontamination of the film of product retained in said lip when said sleeve is the closed state. In a variant, provision can be made for the lip 22 in the closed state to be in contact on a surface of the insert 11 that comprises metallic copper.

1. Dispensing head for a system for dispensing a pressurised product, said head comprising a body having a well for mounting said head on a tube for feeding pressurised product and a housing in communication with said well, said housing being equipped with an insert around which a sleeve is disposed to form a path for dispensing product between said well and a dispensing orifice formed in a wall of said sleeve that is disposed opposite a wall of said insert, said head being characterised in that at least one of the walls of the sleeve and of the insert has a surface intended to be in contact with the product, said surface comprising metallic copper.

2. Dispensing head according to claim 1, characterised in that the sleeve and/or the insert is produced from a synthetic material, at least one surface of which intended to be in contact with the product is metallised with a deposit of copper.

3. Dispensing head according to claim 1, characterised in that the sleeve and/or the insert is produced from metallic copper.

4. Dispensing head according to claim 1, characterised in that the sleeve and/or the insert is produced from synthetic material containing particles of metallic copper.

5. Dispensing head according to claim 1, characterised in that the dispensing orifice is delimited by a peripheral surface that comprises metallic copper.

6. Dispensing head according to claim 1, characterised in that the external and/or internal surface of the wall of the sleeve comprises metallic copper.

7. Dispensing head according to claim 1, characterised in that the sleeve is reversibly deformable between a closed state and an open state of the dispensing orifice.

8. Dispensing head according to claim 1, characterised in that the dispensing orifice has a maximum dimension that is less than or equal to 0.5 mm.

9. Dispensing head according to claim 1, characterised in that the walls of the insert and of the sleeve delimit between them a volume intended to contain product, said volume being less than 0.1 mm3.

10. Dispensing head according to claim 1, characterised in that the insert is reversibly movable between a closure position and an open position of the dispensing orifice.

11. System for dispensing a pressurised product, said system comprising a dispensing head according to claim 1 and tube for feeding pressurised product, on which the mounting well of said head is fixed.

12. System for dispensing according to claim 11, characterised in that it comprises a pump that can be actuated by the dispensing head, said pump comprising the tube for feeding pressurised product.

13. System for dispensing according to claim 12, characterised in that the pump is of the type without take-up of air in compensation for the volume of product dispensed.

14. Bottle containing a product to be dispensed under pressure, said bottle comprising a neck on which a dispensing system according to claim 11 is associated so as to put the feed tube in communication with the product to enable the product to be routed from said feed tube to the dispensing orifice.

15. Bottle according to claim 14, characterised in that it comprises a flexible body.
